(19) United States
(12) Patent Application Publication
(10) Pub. No.: US 2008/0297712 A9
(43) Pub. Date: Dec. 4, 2008

(54) IPS-LCD device having optical compensation films

(75) Inventors: Hiroshi Nagai, Kawasaki (JP); Hidenori Ikeno, Kawasaki (JP)

Correspondence Address: HAYES SOLOWAY P.C., 3450 E. SUNRISE DRIVE, SUITE 140, TUCSON, AZ, 85718, US

(73) Assignee: NEC LCD Technologies, Ltd.

(21) Appl. No.: 11/173,349

(22) Filed: Jul. 1, 2005

(30) Foreign Application Priority Data
Jul. 5, 2004 (JP) 2004-198370

(51) Int. Cl. G02F 1/1343

(52) U.S. Cl. 349/141

(57) ABSTRACT

An IPS-LCD device includes TFT and CF (color filter) substrates sandwiching therebetween an LC layer, first and second polarizing films sandwiching therebetween the pair of substrates, an optical compensation film having a negative single-axis optical anisotropy and sandwiched between the TFT substrate and the first polarizing film, and a second optical compensation film having a two-axis optical anisotropy and sandwiched between the CF substrate and the second polarizing film. The retardation I1 of the first optical compensation film and the retardation I2 of the second optical compensation film satisfy the following relationships: either
240 nm≦I1≦425 nm; and
200 nm≦I2≦(0.75×I1+61)nm, or
500 nm≦I1≦730 nm; and
(0.60×I1−272)nm≦I2≦1830 nm.

### BACKGROUND OF THE INVENTION

(a) Field of the Invention

The present invention relates to an in-plane-switching-mode liquid crystal display (IPS-LCD) device and, more particularly, to an IPS-LCD device having optical compensation films.

(b) Description of the Related Art

An IPS-LCD device uses a parallel electric field for rotating orientations of liquid crystal molecules in the liquid crystal (LC) layer of the LCD device. The IPS-LCD device generally includes an LC layer including homogeneously-oriented LC molecules, a pair of substrates sandwiching therebetween the LC layer, and a pair of polarizing films each attached to a corresponding one of the substrates on the external sides thereof. The IPS-LCD device is generally designed so that the initial orientation of the LC molecules in the LC layer represents a black color without an applied voltage, and so that the orientation of the LC molecules is rotated by about 45 degrees by an applied voltage to represent a white color. The rotational direction of the LC molecules in the IPS-LCD device is parallel to the substrate surface, achieving a higher viewing angle compared to a twisted-nematic-mode LCD device.

It is known in the IPS-LCD device that a high viewing angle can be achieved in an azimuth angle parallel or normal to the optical axes of the polarizing films, i.e., optical absorption axis and optical transmission axis. However, an undesirable chromaticity shift is observed in the IPS-LCD device depending on the viewing angle, as viewed from different viewing angles in the direction of an azimuth angle of 45 degrees away from the optical axes of the polarizing film. A multiple-domain IPS-LCD device is known to solve the problem in which the undesirable chromaticity shift is observed depending on the viewing angle. The multiple-domain IPS-LCD device suppresses the chromaticity shift involved with the change of the viewing angle, by suppressing the azimuth angle dependency thereof while bending the electrodes at a plurality of points.

Another technique is proposed by Patent Publication JP-A-11-133408 to solve the above problem. This technique uses an optical compensation film disposed between the LC layer and the light-emitting-side polarizing film. The optical compensation film has a positive single-axis optical anisotropy, and has an optical axis normal to the substrate surface. The optical compensation film cancels the change of the retardation of the LC layer involved in the change of the viewing angle by using the change of the retardation of the optical compensation film, thereby suppressing the chromaticity shift.

It is noted in the IPS-LCD device that a protective layer configuring part of the polarizing film has a negative single-axis optical anisotropy, wherein the optical axis thereof is normal to the substrate surface. This causes generation of retardation as viewed in a slanted viewing direction. The retardation incurs a phenomenon that the light incident onto the LC layer from a backlight source through the polarizing film is changed to an elliptically-polarized light. The elliptically-polarized light in the IPS-LCD device causes a polarization change of the light passing through the LC layer, thereby generating a leakage light as viewed in the slanted viewing direction. In addition, since the optical axes of the pair of polarizing films do not extend normal to one another if observed in a slanted viewing azimuth angle away from the optical axes, there also arises a leakage light upon representing a black color on the screen. These leakage lights degrade the contrast ratio of the IPS-LCD device as viewed in the slanted direction, and degrade the viewing angle characteristic of the contrast ratio.

The problem of chromaticity shift upon changing the viewing angle in the slanted viewing direction in the IPS-LCD device can be substantially solved by employing the multiple-domain IPS technique as well as by the technique described in the patent publication. However, after the problem of the chromaticity shift is solved, the problem of the leakage lights upon representing a black color on the screen is noticed as a significant problem, although this problem is not considered critical heretofore, i.e., before the chromaticity shift problem is solved. The problem of the leakage lights upon display of a black color cannot be solved either by the multiple-domain IPS technique or by the technique described in the patent publication. Thus, it is now desired to solve the problem of the leakage lights upon display of a black color in the IPS-LCD device.

### SUMMARY OF THE INVENTION

In view of the above, it is an object of the present invention to provide an IPS-LCD device having an improved image quality by suppressing the leakage light in a slanted viewing direction.

The present invention provides an in-plane-switching-mode liquid crystal display (IPS-LCD) device including: a liquid crystal (LC) layer including homogeneously-oriented LC molecules; first and second substrates disposed adjacent to a light-incident side and a light-emitting side, respectively, of the LC layer, the LC molecules having a twisted angle of substantially zero degree and being aligned parallel to a substrate surface which is one of surfaces of the first and second substrates; first and second polarizing films disposed adjacent to a light-incident side of the first substrate and a light-emitting side of the second substrate, respectively; a first retardation film disposed adjacent to one of the first and second substrates; and a second retardation film disposed adjacent to a light-incident side of the second polarizing film,

refractive indexes of the first and second retardation films satisfying the following relationships:
0≦(ns1−nz1)/(ns1−nf1)≦0.5
0≦(ns2−nz2)/(ns2−nf2)≦0.5
where ns1, nf1 and nz1 represent refractive indexes in directions of in-plane slow axis, in-plane fast axis and thickness, respectively, of the first retardation film, and ns2, nf2 and nz2 represent refractive indexes in directions of in-plane slow axis, in-plane fast axis and thickness, respectively, of the second retardation film,

the slow axes of the first and second retardation films extending parallel to the substrate surface, the fast axis of the first retardation film extending parallel to a direction of an initial orientation of the LC layer being projected onto the substrate surface, the slow axis of the second retardation film extending parallel to a direction of the initial orientation of the LC layer being projected onto the substrate surface, in-plane retardations of the first and second retardation films satisfying either the following relationships:
240 nm−I1≦425 nm; and
200 nm≦I2≦(0.75×I1+61)nm,
or the following relationship:
500 nm≦I1≦730 nm; and
(0.60×I1−272)nm≦I2≦180 nm,
where I1 and I2 represent in-plane retardations of the first and second retardation films, respectively, and defined by:
I1=(ns1−nf1)×d1; and
I2=(ns2−nf2)×d2,
d1 and d2 being equivalent thicknesses of the first and second retardation films.

In accordance with the IPS-LCD device of the present invention, the specified relationships between the retardations of the first and second compensation films provide reduction of the leakage light upon display of a black color on the screen of the IPS-LCD device.

The term “equivalent thickness” of a film as used herein means the thickness of the film defined in terms of the thickness of the LC layer having a retardation same as the retardation of the film.

The above and other objects, features and advantages of the present invention will be more apparent from the following description, referring to the accompanying drawings.

### BRIEF DESCRIPTION OF THE DRAWINGS

FIG. 1 is a sectional view of an IPS-LCD device according to a first embodiment of the present invention.

FIGS. 2A and 2B are sectional views of parts of the IPS-LCD device of FIG. 1.

FIG. 3 is a perspective view of a typical LCD device, representing the definitions of an azimuth angle and a viewing angle in the present invention.

FIG. 4 is a perspective view of an optical compensation film, representing symbols in the definition of retardation of the optical compensation film.

FIG. 5 is a three-dimensional graph showing the relationship between the combination of retardations of optical compensation films and the leakage light in a slanted viewing direction.

FIG. 6 is a two-dimensional graph showing the relationship between the combination of retardations of optical compensation films and the leakage light in the slanted viewing direction.

FIG. 7 is a graph showing the range of combination of optical compensation films achieving a preferable reduction of the leakage light upon displaying a black color on the screen.

FIG. 8 is a sectional view of an IPS-LCD device according to a second embodiment of the present invention.

### PREFERRED EMBODIMENT OF THE INVENTION

Now, the present invention is more specifically described with reference to accompanying drawings, wherein similar constituent elements are designated by similar reference numerals.

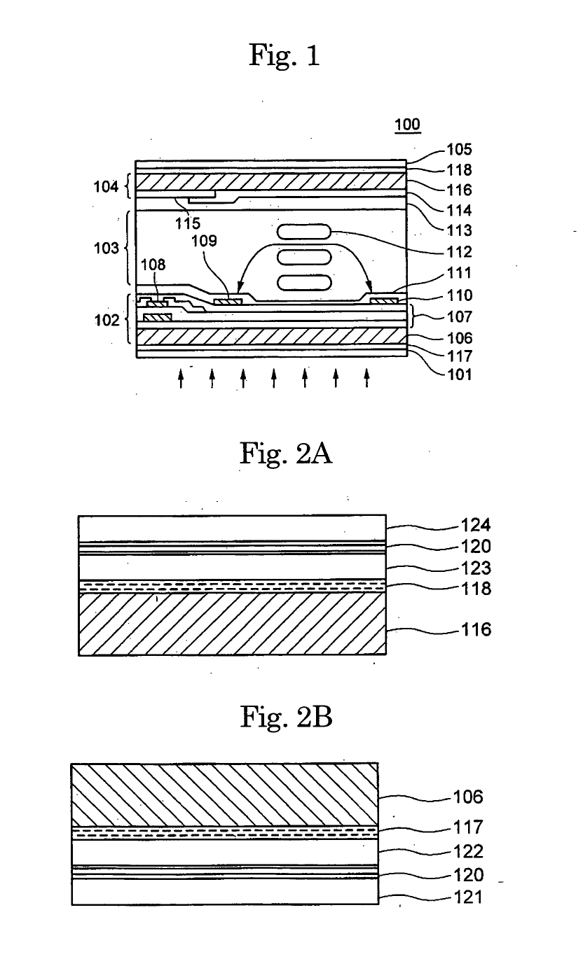

Referring to FIG. 1, an IPS-LCD device, generally designated by numeral 100, according to a first embodiment of the present invention includes a first (light-incident-side) polarizing film 101, a first optical compensation film 117, a TFT substrate 102, an LC layer 103, a CF (color-filter) substrate 104, a second optical compensation film 118 and a second polarizing film 105, which are consecutively arranged in this order as viewed from a backlight source, or from the bottom of the drawing. The first and second polarizing films 101 and 105 may be referred to as light-incident-side polarizing film and light-emitting-side polarizing film, respectively, in this text.

The LC layer 103 has a twisted angle of about zero degree, and includes homogeneously-oriented LC molecules 112, which have longer axes extending parallel to the substrate surface, or the surface of the TFT or CF substrate. The LC layer 103 may be a positive-type LC layer or a negative-type LC layer. Between the LC layer 103 and each of the TFT substrate 102 and CF substrate 104, there is provided an orientation film 111 or 113.

The TFT substrate 102 includes a glass substrate body 106, an insulating film 107, and an array of pixels each including a TFT 108, a pixel electrode 109 and a common electrode 110. The insulating film 107 includes an organic layer and a silicon nitride layer. The TFT 108 controls the potential applied to the corresponding pixel electrode 109. In this IPS-LCD device 100 of FIG. 1, the pixel electrode 109 and the common electrode 110, both of which are formed on the TFT substrate 102, apply a lateral electric field to the LC molecules 112 in the LC layer 103 due to a potential difference therebetween.

The CF substrate 104 includes coloring layers 114, a light shield film 115 and a glass substrate body 116. The coloring layers 114 apply three primary colors to the light passed by the LC layer 103 depending on the pixels. The light shield film 115 shields the TFTs 108 and signal lines not shown in the drawing against the light.

FIGS. 2A and 2B are enlarged views showing details of parts of the IPS-LCD device of FIG. 1. As shown in FIG. 2B, the first polarizing film 101 attached onto the glass substrate body 106 of the TFT substrate 102 has a three-layer structure, wherein a polarizing layer 120 is sandwiched between first protective layer 121 and a second protective layer 122. Similarly, the second polarizing film 105 attached onto the glass substrate 116 of the CF substrate 104 has a three-layer structure, wherein a polarizing layer 120 is sandwiched between a third protective layer 123 and a fourth protective layer 124.

The polarizing layer 120 is made of, for example, polyvinyl alcohol (PVA), and changes the incident light into a substantially-linearly-polarized light. Each of the protective layers 121 to 124 is made of, for example, triacetyl cellulose (TAC), and acts as a retardation film having an optical axis in the thickness direction thereof and a negative single-axis optical anisotropy. It is assumed here that the refractive-index ellipsoid of each protective layer has three orthogonal optical elastic axes including a first axis having a largest refractive index of nx, a second axis having a second-largest refractive index of ny and a third axis having a smallest refractive index of nz. In this embodiment, the value of nx is substantially equal to the value of ny and the third axis having the refractive index of nz is substantially normal to the substrate surface.

The first and second optical compensation films 117 and 118 constitute retardation films and have respective optical characteristics. The optical compensation film 117 or 118 may be formed by bonding or coating, for example, onto the glass substrate body 106 or 116. The three optical elastic axes of each optical compensation film 117 or 118 include an in-plane slow axis and an in-plane fast axis which are parallel to the substrate surface, and another axis which is normal to the substrate surface.

The first optical compensation film 117 has a negative single-axis optical anisotropy, and is disposed between the first polarizing film 101 and the TFT substrate 102. The first optical compensation film 117 may be made from a specific film which includes a discotic LC layer having an in-plane optical axis and a negative single-axis optical anisotropy, or another film having similar characteristics. The optical axis of the first optical compensation film 117 is designed to substantially align with the slow axis of the LC layer 103, wherein the deviation therebetween should be preferably within ±2 degrees.

When the light passes through the first polarizing film 101, the light first assumes a linearly-polarized light due to the function of the polarizing layer 120 of the first polarizing film 101, and then assumes a slightly-elliptically-polarized light due to the function of the protective layer 122 of the first polarizing film 101. After the slightly-elliptically-polarized light passes through the LC layer 103, the light reaches the second polarizing film 105 in the state of having different polarized components having respective wavelengths due to the retardation wavelength dispersion. Since the first optical compensation film 117 has a negative single-axis optical anisotropy, which is opposite to the positive single-axis optical anisotropy of the LC layer 103, the first optical compensation film 117 compensates the retardation wavelength dispersion caused by the LC layer 103, more specifically, compensates the retardations between the wavelength components. Thus, the second polarizing film 105 receives the compensated light having a desirable polarization.

The second optical compensation film 118 has a two-axis optical anisotropy or a negative single-axis optical anisotropy, and is disposed adjacent to the light incident side of the second polarizing film 105. The second optical compensation film 118 may be formed from a film by extending the film as by pressing, so long as the film has a two-axis optical anisotropy, for example. The slow axis of the second optical compensation film 118 is designed to align with the slow axis of the LC layer 103, wherein deviation between both the slow axes should be preferably within ±2 degrees.

If a typical LCD device such as 100 shown FIG. 1 is observed in the azimuth direction, which is 45 degrees away from the optical axes of the polarizing films 101 and 105, from a significant viewing angle with respect to the normal direction, then the optical axes of both the polarizing films 101 and 105 are observed to deviate from the right angle. The optical compensation film 118 compensates this deviation from the right angle caused by the different birefringences, which depend on the viewing directions.

By the functions of both the optical compensation films 117 and 118 as described above, the light incident onto the second polarizing film 105 has a desirable polarization, whereby the leakage light and chromaticity shift problems appearing as observed in all the directions can be suppressed. In particular, the leakage light upon display of a black color can be suppressed down to a desired level.

It is noted here that the optical compensation using the second optical compensation film 118 may involve problems of leakage light and chromaticity shift because the second is optical compensation film 118 generates retardation wavelength dispersion to thereby generate different polarized components depending on the wavelengths. In such a case, however, the first optical compensation film 117 controls the polarization of the light incident onto the second optical compensation film 118, whereby the light emitted through the second optical compensation film 118 has a uniform polarization. Although the light incident onto the second polarizing film 105 may be changed in the polarization thereof by the third optical compensation film 123, the second optical compensation film 118 controls the polarization of the light incident onto the polarizing layer 120 of the second polarizing film 105, thereby aligning the polarization of the light emitted through the third protective layer 123.

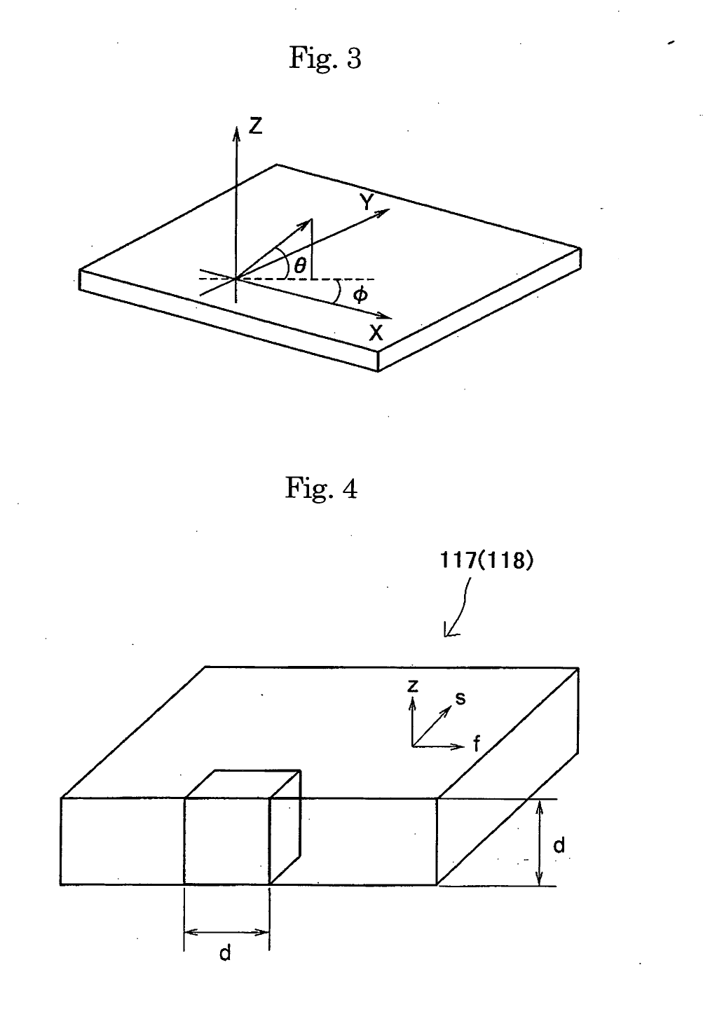

The present inventors conducted simulations for the optical characteristics of the optical compensation films 117 and 118 of the IPS-LCD device 100 having the configuration as described above, to obtain the conditions which provide superior suppression of the leakage light upon display of a black color on the screen down to a desired level. In these simulations, a viewing angle of θ=70 degrees was employed in the azimuth direction which is at an azimuth angle φ=45 degrees, given viewing angle θ and azimuth angle φ being shown in FIG. 3. More specifically, in FIG. 3, the azimuth angle φ is defined by an angle between a dotted line obtained by projecting an arbitrary vector representing the viewing point of an observer onto the X-Y plane and the X-axis, whereas the viewing angle θ is defined by an angle between the arbitrary vector and the X-Y plane.

FIG. 4 shows the definition of retardation of the optical compensation film in this text. The in-plane retardation is generally defined by:
(ns−nf)×d,
assuming that ns is the refractive index in the direction of the in-plane slow axis, nf is the refractive index in the direction of the in-plane fast axis, nz is the refractive index in the thickness direction, and d is the equivalent thickness of the film. The term “retardation” may be referred to as or attached with (Δn·d) in this text.

The first optical compensation film 117 used in the simulations had an optical characteristic represented by:
(ns−nz)=0,
whereas the second optical compensation film 118 had an optical characteristic represented by:
0≦(ns−nz)/(ns−nf)≦0.5.

The present inventors confirmed in an experiment, prior to the simulations, the intensity level of the backlight at which the leakage light in the slanted viewing direction did not substantially degrade the image quality, while lowering the intensity of the backlight unit in a typical IPS-LCD device. The results of the experiment revealed that a half of the ordinary intensity level (standard level) of the backlight prevented the leakage light in the slanted viewing direction from significantly degrading the image quality, and that a quarter of the standard level prevented the leakage light itself from being perceived. Thus, we employed the half of the standard level in the simulations for the intensity level of the leakage light in the slanted viewing direction, as the desired level at which the leakage light does not substantially degrade the image quality for the IPS-LCD device of the present invention.

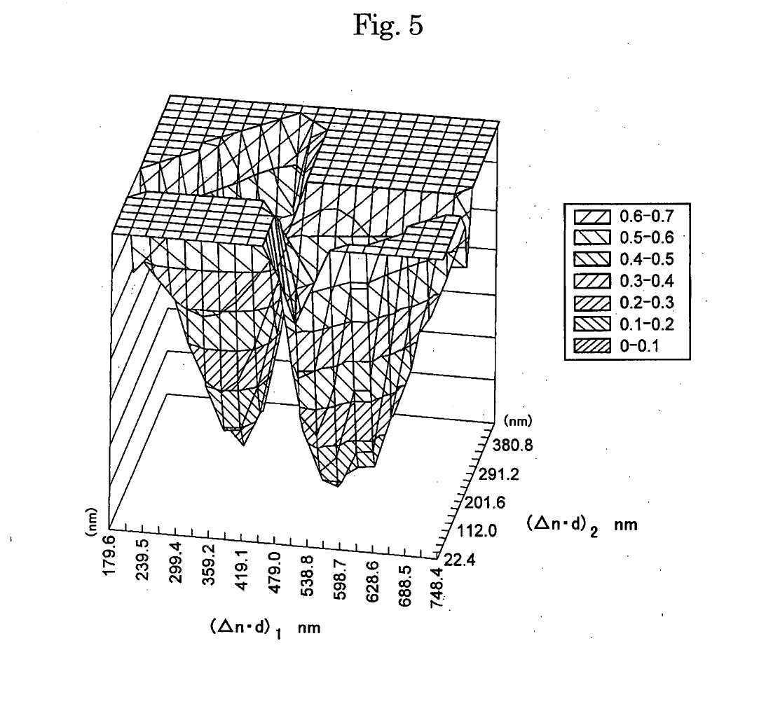

FIG. 5 is a three-dimensional graph showing the relationship between a combination of the retardations of the optical compensation films 117 and 118 and the intensity of leakage light in the slanted viewing direction. In this figure, the intensity of leakage light is normalized by the standard level which is the intensity of leakage light in the ordinary IPS-LCD device in the slanted viewing direction. The retardation of the optical compensation film 117 is represented by (Δn·d)1, whereas the retardation of the optical compensation film 118 is represented by (Δn·d)2 in the graph of FIG. 5.

It will be understood from FIG. 5 that a desirable level of the intensity of leakage light which is equal to or lower than a half (0.5) of the standard level can be achieved by employing a specific combination of the optical compensation films 117 and 118.

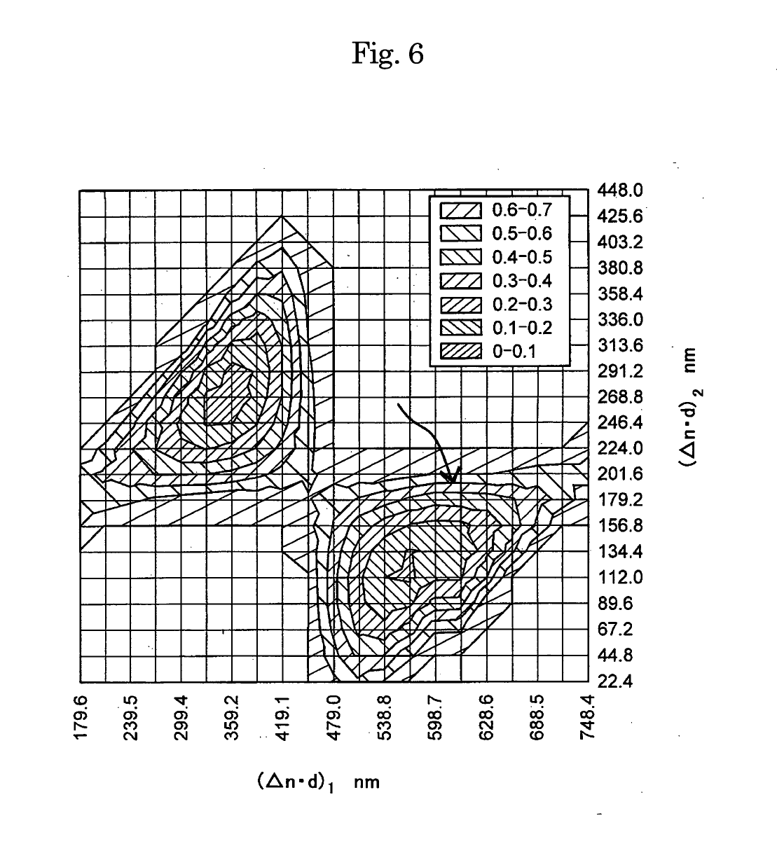

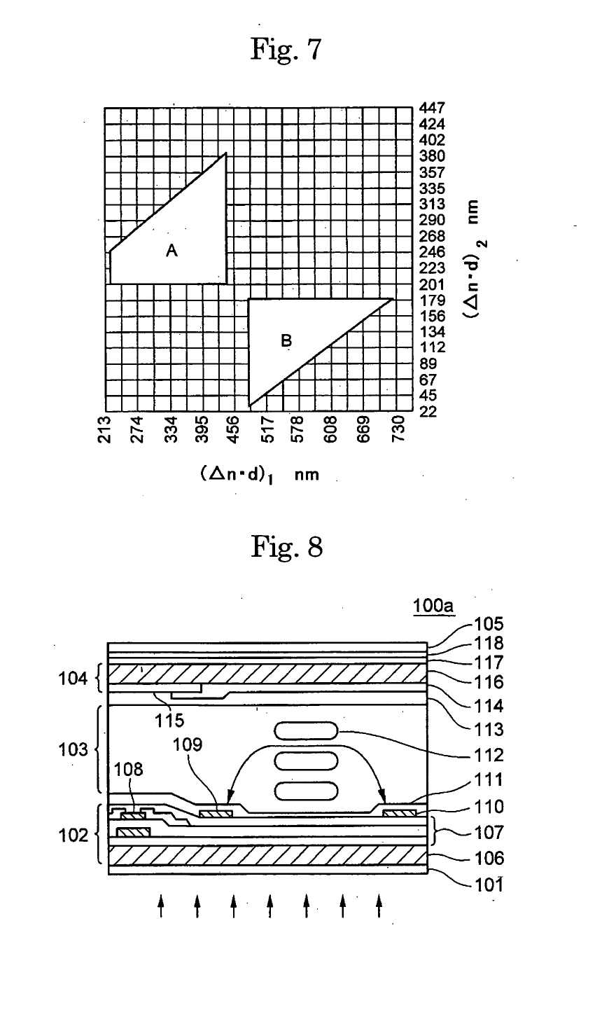

FIG. 6 shows the graph of FIG. 5 in a two-dimensional representation, showing the relationship between the combination of retardations (Δn·d)₁ and (Δn·d)₂ and the normalized intensity of leakage light. FIG. 7 shows the specific areas including area A and area B which approximate the areas of FIG. 6 achieving the desirable intensity of leakage light which is equal to or lower than half the standard level.

The two areas (area A and area B) shown in FIG. 7 achieving half the standard level or lower can be defined using linear formulas:

For area A,
240 nm≦(Δn·d)₁≦425 nm, and
200 nm≦(Δn·d)₂≦(0.75×(Δn·d)₁+61) nm;

For area B.
500 nm≦(Δn·d)₁≦730 nm, and
(0.60×(Δn·d)₁−272)nm≦(Δn·d)₂≦180 nm.

In one embodiment of the present invention, the combination of retardations of the optical compensation films 117 and 118 is set to stay within the area A or area B as shown in FIG. 7, thereby achieving the desirable level of leakage light in the slanted viewing direction, which is half the standard level or lower. It is considered that the setting of the combination of retardations within the areas A and B allows the optical compensation films 117 and 118 to suppress the optical dispersion caused by the second protective layer 122 in the first polarizing film 101, LC layer 103 and CF substrate, and to thereby obtain a less amount of dispersion in the light on the surface of the polarizing layer 120 in the second polarizing film 105. In the present embodiment, the thus achieved low level of the leakage light improves the image quality of the IPS-LCD device.

FIG. 8 shows an IPS-LCD device according to a second embodiment of the present invention. The IPS-LCD of the present embodiment is similar to the first embodiment except that the optical compensation film 117 is disposed adjacent to the CF substrate 104 between the optical compensation film 118 and the LC layer 103 in the present embodiment. Simulations conducted for the LCD device of the present embodiment revealed results similar to those shown in FIG. 5 in the first embodiment. Thus, the combination of retardations of the optical compensation films 117 and 118 should be determined to stay within area A or B shown in FIG. 7, to reduce the leakage light in the slanted viewing direction upon display of a black color.

It should be noted that the optical compensation film 117 may have a two-axis optical anisotropy instead of the negative single-axis optical anisotropy. In this case, the optical characteristics of the optical compensation films 117 and 118 should preferably satisfy the following relationship:
0Z1≦Z2≦0.5
where Z1 is the optical characteristic of the optical compensation film 117 and expressed by:
Z1=(ns1−nz1)/(ns1−nf1),
and Z2 is the optical characteristic of the optical compensation film 118 and expressed by:
Z2=(ns2−nz2)/(ns2−nf2).
In this case, the two-axis optical anisotropy of the optical compensation film 117 should preferably be close to the negative single-axis optical anisotropy.

Since the above embodiments are described only for examples, the present invention is not limited to the above embodiments and various modifications or alterations can be easily made therefrom by those skilled in the art without departing from the scope of the present invention.

1. An in-plane-switching-mode liquid crystal display (IPS-LCD) device comprising: a liquid crystal (LC) layer including homogeneously-oriented LC molecules; first and second substrates disposed adjacent to a light-incident side and a light-emitting side, respectively, of said LC layer, said LC molecules having a twisted angle of substantially zero degree and being aligned parallel to a substrate surface which is one of surfaces of said first and second substrates; first and second polarizing films disposed adjacent to a light-incident side of said first substrate and a light-emitting side of said second substrate, respectively; a first retardation film disposed adjacent to one of said first and second substrates; and a second retardation film disposed adjacent to a light-incident side of said second polarizing film, refractive indexes of said first and second retardation films satisfying the following relationships:
0≦(ns1−nz1)/(ns1−nf1)≦0.5
0≦(ns2−nz2)/(ns2−nf2)≦0.5
where ns1, nf1 and nz1 represent refractive indexes in directions of in-plane slow axis, in-plane fast axis and thickness, respectively, of said first retardation film, and ns2, nf2 and nz2 represent refractive indexes in directions of in-plane slow axis, in-plane fast axis and thickness, respectively, of said second retardation film,
said slow axes of said first and second retardation films extending parallel to said substrate surface, said fast axis of said first retardation film extending parallel to a direction of an optical axis of an initial orientation of said LC layer being projected onto said substrate surface, said slow axis of said second retardation film extending parallel to a direction of an optical axis of the initial orientation of said LC layer being projected onto said substrate surface,
in-plane retardations of said first and second retardation films satisfying the following relationships:
240 nm≦I1≦425 nm; and
200 nm≦I2≦(0.75×I1+61)nm,
where I1 and I2 represent in-plane retardations of said first and second retardation films, respectively, and defined by:
I1=(ns1−nf1)×d1; and
I2=(ns2−nf2)×d2,
d1 and d2 being equivalent thicknesses of said first and second retardation films.

2. The IPS-LCD device according to claim 1, wherein the following relationship holds:
Z1≦Z2,
where Z1=(ns1−nz1)/(ns1−nf1) and Z2=(ns2−nz2)/(ns2−nf2).

3. The IPS-LCD device according to claim 1, wherein said first retardation film has a two-axis optical anisotropy or negative single-axis optical anisotropy.

4. The IPS-LCD device according to claim 1, wherein said second retardation film has a two-axis optical anisotropy or negative single-axis optical anisotropy.

5. The IPS-LCD device according to claim 1, wherein an angle of said fast axis of said first retardation film with respect to said direction of said optical axis of said initial orientation of said LC layer being projected onto said substrate surface is within ±2 degrees.

6. The IPS-LCD device according to claim 1, wherein an angle of said slow axis of said second retardation film with respect to said direction of said optical axis of said initial orientation of said LC layer being projected onto said substrate surface is within ±2 degrees.

7. The IPS-LCD device according to claim 1, wherein each of said first and second polarizing films includes a polarizing layer having a function of converting incident light to a linearly-polarized light, and a pair of protective layers sandwiching therebetween said polarizing layer, a refractive index ellipsoid of each of said protective layers having three orthogonal optical elastic axes including a first axis having a largest refractive index of nx, a second axis having a second-largest refractive index of ny and a third axis having a smallest refractive index of nz, said nx being substantially equal to said ny, said third axis extending substantially normal to said substrate surface.

8. The IPS-LCD device according to claim 1, wherein said LC layer includes positive-type LC.

9. The IPS-LCD device according to claim 1, wherein said LC layer includes negative-type LC.

10-18. (canceled)

19. An in-plane-switching-mode liquid crystal display (IPS-LCD) device comprising: a liquid crystal (LC) layer including homogeneously-oriented LC molecules; first and second substrates disposed adjacent to a light-incident side and a light-emitting side, respectively, of said LC layer, said LC molecules having a twisted angle of substantially zero degree and being aligned parallel to a substrate surface which is one of surfaces of said first and second substrates; first and second polarizing films disposed adjacent to a light-incident side of said first substrate and a light-emitting side of said second substrate, respectively; a first retardation film disposed adjacent to one of said first and second substrates; and a second retardation film disposed adjacent to a light-incident side of said second polarizing film,
refractive indexes of said first and second retardation films satisfying the following relationships:
0<(ns1−nz1)/(ns1−nf1)<0.5
0<(ns2−nz2)/(ns2−nf2)<0.5
where ns1, nf1 and nz1 represent refractive indexes in directions of in-plane slow axis, in-plane fast axis and thickness, respectively, of said first retardation film, and ns2, nf2 and nz2 represent refractive indexes in directions of in-plane slow axis, in-plane fast axis and thickness, respectively, of said second retardation film,
said slow axes of said first and second retardation films extending parallel to said substrate surface, said fast axis of said first retardation film extending parallel to a direction of an optical axis of an initial orientation of said LC layer being projected onto said substrate surface, said slow axis of said second retardation film extending parallel to a direction of an optical axis of the initial orientation of said LC layer being projected onto said substrate surface,
in-plane retardations of said first and second retardation films satisfying the following relationships:
319 nm≦I1≦425 nm; and
300 nm<I2≦(0.75×I1+61)nm,
where I1 and I2 represent in-plane retardations of said first and second retardation films, respectively, and defined by:
I1=(ns1−nf1)×d1; and
I2=(ns2−nf2)×d2,
d1 and d2 being equivalent thicknesses of said first and second retardation films.

20. The IPS-LCD device according to claim 19, wherein the following relationship holds:
Z1<Z2,
where Z1=(ns1−nz1)/(ns1−nf1) and Z2=(ns2−nz2)/(ns2−nf2).

21. The IPS-LCD device according to claim 19, wherein said first retardation film has a two-axis optical anisotropy or negative single-axis optical anisotropy.

22. The IPS-LCD device according to claim 19, wherein said second retardation film has a two-axis optical anisotropy or negative single-axis optical anisotropy.

23. The IPS-LCD device according to claim 19, wherein an angle of said fast axis of said first retardation film with respect to said direction of said optical axis of said initial orientation of said LC layer being projected onto said substrate surface is within ±2 degrees.

24. The IPS-LCD device according to claim 19, wherein an angle of said slow axis of said second retardation film with respect to said direction of said optical axis of said initial orientation of said LC layer being projected onto said substrate surface is within ±2 degrees.

25. The IPS-LCD device according to claim 19, wherein each of said first and second polarizing films includes a polarizing layer having a function of converting incident light to a linearly-polarized light, and a pair of protective layers sandwiching therebetween said polarizing layer, a refractive index ellipsoid of each of said protective layers having three orthogonal optical elastic axes including a first axis having a largest refractive index of nx, a second axis having a second-largest refractive index of ny and a third axis having a smallest refractive index of nz, said nx being substantially equal to said ny, said third axis extending substantially normal to said substrate surface.

26. The IPS-LCD device according to claim 19, wherein said LC layer includes positive-type LC.
